(19) United States
(12) Patent Application Publication
(10) Pub. No.: US 2010/0075526 A1
(43) Pub. Date: Mar. 25, 2010

(54) ELECTRONIC DEVICE ASSEMBLY

(75) Inventors: Chih-Chung Chiu, Taipei City (TW); Huang-Lin Lee, Taipei City (TW); Hung-yuan Lai, Taipei City (TW); Chung-Kuan Wang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/323,481

(22) Filed: Nov. 26, 2008

(30) Foreign Application Priority Data
Sep. 25, 2008 (TW) 97136979

(51) Int. Cl. H01R 13/625

(52) U.S. Cl. 439/345

(57) ABSTRACT

An electronic device assembly includes an electronic device and a mini connector. The electronic device includes a first housing. The first housing includes an assembling opening, a first positioning portion located adjacent to the assembling opening, and a first connecting terminal set located in the assembling opening. The mini connector includes a second housing, a connecting wire, and a second connecting terminal set. The second housing includes a second positioning portion having a shape complementary to that of the first positioning portion. The connecting wire passing through the second housing is electrically connected to the second connecting terminal set located in the second housing. The second positioning portion is located at one side of the second connecting terminal set. With the complementary relationship between the shapes of the second positioning portion and the first positioning portion, the mini connector is configured to be connected only to the electronic device.

### CROSS-REFERENCE TO RELATED APPLICATION

This application claims the priority benefit of Taiwan application serial no. 97136979, filed on Sep. 25, 2008. The entirety of the above-mentioned patent application is hereby incorporated by reference herein and made a part of specification.

### BACKGROUND OF THE INVENTION

1. Field of the Invention

The present invention generally relates to an electronic device assembly, and more particularly, to an electronic device assembly for anti-misplug of a mini connector.

2. Description of Related Art

In the information era nowadays, people are relying more and more on electronic devices. For example, cell phones, personal digital assistants (PDAs), and mobile internet devices (MIDs) are being widely used in our lives. Electronic devices have become indispensable to people lives.

Although the function of the electronic device is limited by the design requirement of being light, thin and small, the electronic device can still be connected with other expansion devices to expand its function. For example, cell phones usually can be connected to a computer for data exchange, internet connection or charging. The previous electronic devices introduced by different manufacturers had incompatible connecting interface specification for the consideration of market monopoly, brand identification or other special function. Therefore, the electronic devices must be connected to different charging devices through different connectors. As such, it can be inconvenient to use the electronic device as well as store the connectors.

In response to the user's needs that different electronic devices can commonly use connectors with a same specification to increase the ease of use and the company's consideration of pursing high profit by reducing the research and develop cost, the electronic devices are gradually adopting the uniform connecting interface specification. Accordingly, a connector complimentary with an electronic device can be commonly used between different electronic devices or between the electronic device and an expansion device.

For example, when using a connector with one end for charging and the other end being a universal serial bus (USB) interface, electronic devices having different function, such as, a cell phone and a mobile internet device, require different voltage or current. Although manufacturers may put an identification or mark on the connector to facilitate the user identifying whether the connector is adapted for use with a cell phone, which requires a small current or voltage, or is adapted for use with an MID, which requires a large current or voltage, the user may often mistakingly plug a connector which is adapted for use with the MID into a cell phone. As such, the overlarge current or voltage may reduce the lifetime of the cell phone or cause a short circuit which would damage the cell phone.

### SUMMARY OF THE INVENTION

Accordingly, the present invention is directed to an electronic device assembly that can avoid damage to an electronic device caused by misplug of a mini connector.

The present invention provides an electronic device assembly including an electronic device and a mini connector. The electronic device includes a first housing. The first housing includes an assembling opening, a first positioning portion located adjacent to the assembling opening, and a first connecting terminal set located in the assembling opening. The mini connector is configured so as to be connected to the electronic device and includes a second housing, a connecting wire, and a second connecting terminal set. The second housing includes a second positioning portion having a shape complementary to a shape of the first positioning portion. The connecting wire passes through the second housing and is electrically connected to the second connecting terminal set. The second connecting terminal set is located in the second housing. The second positioning portion is located at one side of the second connecting terminal set. With the complementary relationship between the shape of the second positioning portion and the shape of the first positioning portion, the mini connector is configured to be connected only to the electronic device. The second connecting terminal set passes through the assembling opening when the mini connector is connected to the electronic device.

According to one embodiment of the present invention, the electronic device is a personal digital assistant, a smart phone, or a mobile internet device.

According to one embodiment of the present invention, the first positioning portion is a concave in shape and the second positioning device is a projection in shape.

According to one embodiment of the present invention, the first connecting terminal set includes five signal terminals and five charging terminals, and the second connecting terminal set includes five signal terminals and five charging terminals corresponding to the five signal terminals and five charging terminals of the first connecting terminal set.

According to one embodiment of the present invention, the second housing further includes two cantilever hooks located at opposite sides of the second positioning portions, and the first housing further has two openings located at opposite sides of the first positioning portion.

In the electronic device assembly of the present invention, with the complementary engagement of the second positioning portion of the mini connector with the first positioning portion of the electronic device, the mini connector can only be connected to a specific electronic device. Thus, misplug of the mini connector into another electronic device can be avoided, thereby avoiding damage to the electronic device caused by incompatibility of electrical current or voltage.

In order to make the aforementioned and other features and advantages of the present invention more comprehensible, embodiments accompanied with figures are described in detail below.

### BRIEF DESCRIPTION OF THE DRAWINGS

FIG. 1 is an exploded view of an electronic device assembly according to one embodiment of the present invention.

FIG. 2 is a perspective view of the mini connector of FIG. 1.

FIG. 3 is an assembled view of the electronic device assembly of FIG. 1.

FIG. 4 is a top view of the mini connector of FIG. 1.

### DESCRIPTION OF THE EMBODIMENTS

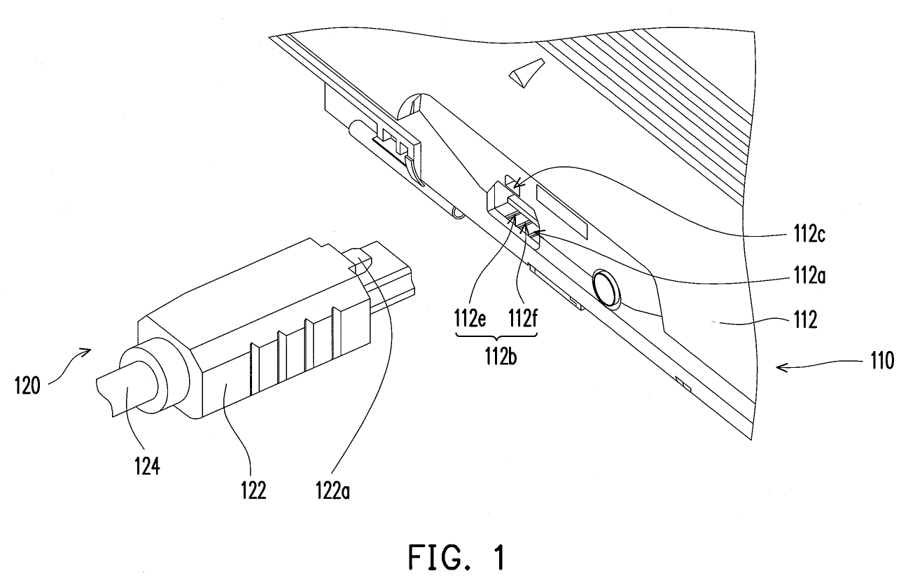

FIG. 1 is an exploded view of an electronic device assembly according to one embodiment of the present invention. Referring to FIG. 1, the electronic device assembly 100 includes an electronic device 110 and a mini connector 120. The electronic device 110 is, for example, a personal digital assistant (PDA), a smart phone, or a mobile internet device (MID). The electronic device 110 includes a first housing 112. The first housing 112 has an assembling opening 112a, a first connecting terminal set 112b, and a first positioning portion 112c. The assembling opening 112a is defined in one side of the first housing 112. The first connecting terminal set 112b is disposed in the assembling opening 112a and is of, for example, a mini universal serial bus (Mini USB) interface. The first connecting terminal assembly 112b includes five signal terminals 112e and five terminals 112f for charging (briefly referred to as “charging terminals”). The first positioning portion 112c is positioned on one side of the housing 112 adjacent to the assembling opening 112a. The first positioning portion 112c is, for example, a concave in shape. The shape of the first positioning portion 112c may vary according to actual requirements and should not be limited to the particular shape described herein.

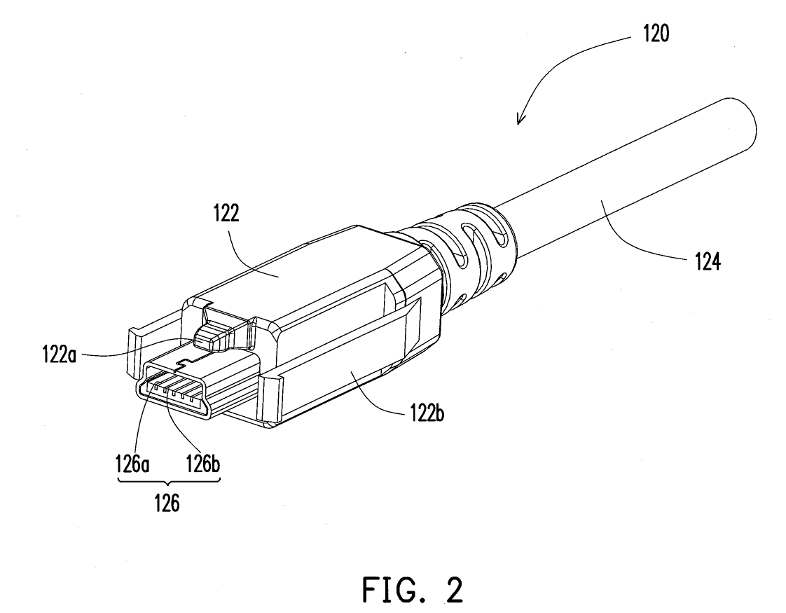

FIG. 2 is a perspective view of the mini connector of FIG. 1. Referring to FIGS. 1 and 2, the mini connector 120 includes a second housing 122, a connecting wire 124, and a second connecting terminal set 126. The second housing 122 includes a second positioning portion 122a. The second positioning portion 122a is disposed at one side of the second connecting terminal set 126, for example, disposed at an upper side or a lower side of the second connecting terminal set 126. The shape of the second positioning portion 122a is complementary to the shape of the first positioning portion 112c. In the present embodiment, the second positioning portion 122a is, for example, a projection to be complementarily engaged in the concave of first positioning portion 112c. One end of the connecting wire 124 passes through the second housing 122 and is electrically connected to the second connecting terminal set 126. In addition, the other end of the connecting wire may be connected to a USB connector or a power plug depending upon actual requirements.

The second connecting terminal set 126 is disposed in the second housing 122 with one end of the second connecting terminal set 126 exposed out of the second housing 122. The end of the second connecting terminal set 126 can be removably connected to the electronic device 110. The mini connector 120 can be electrically connected to the electronic device 110 through the second connecting terminal set 126, such that the electronic device 110 can be electrically charged or perform data transmitting with another electronic device (not shown). In particular, the second connecting terminal set 126 is of a mini USB interface and includes five signal terminals 126a and five charging terminals 126b corresponding to the five signal terminals 112e and five charging terminals 112f of the first connecting terminal set 112b.

To connect the mini connector 120 to the electronic device 110, a user plugs the mini connector 120 into the electronic device 110 such that the second connecting terminal set 126 of the mini connector 120 passes through the assembling opening 112a of the first housing 112 and is connected to the first connecting terminal set 112b. At this time, the signal terminals 112e of the first connecting terminal set 112b contact with the signal terminals 126a of the second connecting terminal set 126 for signal transmitting, and the charging terminals 112f of the first connecting terminal set 112b contact with the charging terminals 126b of the second connecting terminal set 126. When the other end of the connecting wire 124 is connected to a USB connector which is connected to another electronic device (not shown), the another electronic device and the electronic device 110 can transmit data therebetween through the electrical connection between the first connecting terminal set 112b and the second connecting terminal set 126. In the present embodiment, the signal terminals 112e, 126a and the charging terminals 112f, 126b are only illustrative. In alternative embodiments, the number of the signal terminals 112e, 126a and the charging terminals 112f, 126b could vary according to actual requirements.

In particular, because of the complementary relationship between the shape of the second positioning portion 122a and the shape of the first positioning portion 112c, the mini connector 120 can only be connected to the electronic device 110 in a fixed direction. In other words, the user cannot plug the mini connector 120 into the electronic device 110 in an incorrect direction. In addition, the mini connector 120 cannot be plugged into an electronic device without a corresponding first positioning portion 112c. As such, misplug of the mini connector 120 into other electronic devices can be avoided, thereby avoiding short-circuit problem of the electronic device due to incompatibility of electrical current or voltage.

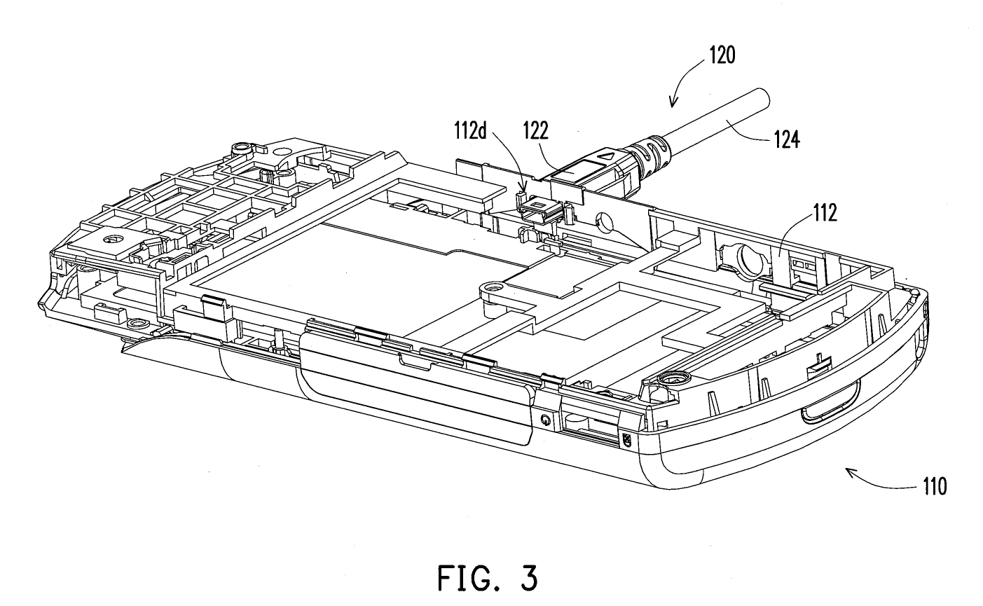

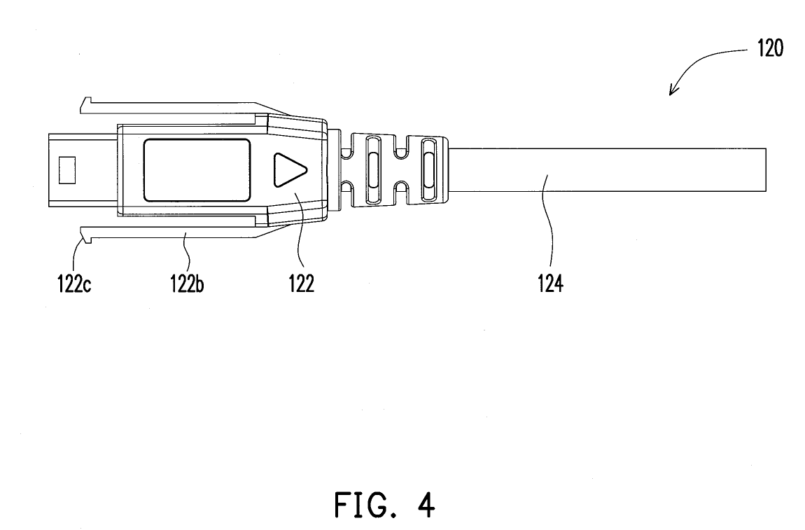

FIG. 3 is an assembled view of the electronic device assembly of FIG. 1. FIG. 4 is a top view of the mini connector of FIG. 1. Referring to FIGS. 3 and 4, the first housing 112 may further include two openings 112d positioned at opposite sides of the first positioning portion 112c (shown in FIG. 1), and the second housing 122 may further include two cantilever hooks 122b corresponding to the two openings 112d. Each cantilever hook 122b has a beveled guiding surface 122c. When the mini connector 120 is being inserted into the electronic device 110, the beveled guiding surface 122c of each cantilever hook 122b passes through a corresponding one of the openings 112d along an edge of the opening 112d and the cantilever hooks 122b are deformed toward each other to allow the cantilever hooks to pass through the openings 112d. After the beveled guiding surfaces 122c have completely passed through the openings 112d, the cantilever hooks 122b are engaged with the edges of the openings 112d, such that the mini connector 120 can be securely connected to the electronic device 110.

When it is desired to remove the mini connector 120 from the electronic device 110, the cantilever hooks 122b can be simply pressed in a direction toward the second positioning portion 122a to disengage the cantilever hooks 122b from the openings 112d, and then the mini connector 120 can be readily disengaged from the electronic device 110. By the engagement of the two cantilever hooks 122b of the second housing 122 with the first housing 112, the mini connector 120 can be more securely retained to the electronic device 110. In the present embodiment, the retaining is achieved by using two cantilever hooks 122b engaged in two openings. In alternative embodiments, however, the mini connector 120 can be retained to the electronic device 110 in various other ways as long as the secure retaining can be achieved.

In summary, in the electronic device assembly of the present invention, with the complementary engagement of the second positioning portion of the mini connector with the first positioning portion of the electronic device, the user can easily identify the mini connector and the electronic device that are adapted to be used in combination and therefore will not mistakingly plug the mini connector into other electronic devices which are not used in combination with the mini connector. As such, connection of the electronic device to another electronic device requiring a different electrical current or voltage can be avoided, thereby avoiding damage caused by such connection and increasing the safety in the use of the electronic devices. In addition, the cantilever hooks of the mini connector can provide more secure retaining of the mini connector to the electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An electronic device assembly comprising:
an electronic device including a first housing, the first housing including an assembling opening, a first positioning portion located adjacent to the assembling opening, and a first connecting terminal set located in the assembling opening; and
a mini connector configured so as to be connected to the electronic device including a second housing, a connecting wire, and a second connecting terminal set, the second housing including a second positioning portion having a shape complementary to a shape of the first positioning portion, the connecting wire being electrically connected to the second connecting terminal set, the second connecting terminal set located in the second housing, the second positioning portion located at one side of the second connecting terminal set;
wherein, with the complementary relationship between the shape of the second positioning portion and the shape of the first positioning portion, the mini connector is configured to be connected only to the electronic device, and the second connecting terminal set passes through the assembling opening when the mini connector is connected to the electronic device, and no electrical terminals are disposed at the first positioning portion and the second positioning portion.

2. The electronic device assembly according to claim 1, wherein the electronic device is a personal digital assistant, a smart phone, or a mobile internet device.

3. The electronic device assembly according to claim 1, wherein the first positioning portion is a concave in shape and the second positioning device is a projection in shape.

4. The electronic device assembly according to claim 1, wherein the first connecting terminal set includes five signal terminals and five charging terminals, and the second connecting terminal set includes five signal terminals and five charging terminals corresponding to the five signal terminals and five charging terminals of the first connecting terminal set.

5. The electronic device assembly according to claim 1, wherein the second housing further includes two cantilever hooks located at opposite sides of the second positioning portions, and the first housing further has two openings located at opposite sides of the first positioning portion.
